(19) United States
(12) Patent Application Publication
(10) Pub. No.: US 2008/0207189 A1
(43) Pub. Date: Aug. 28, 2008

(54) Remote Control Interface

(75) Inventor: Theo Vergoossen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,324

(22) PCT Filed: Sep. 14, 2005
(86) PCT No.: PCT/IB05/53010

§ 371 Date: Mar. 15, 2007

(30) Foreign Application Priority Data
Sep. 20, 2004 (EP) 04104524.6

(51) Int. Cl. H04M 3/00

(52) U.S. Cl. 455/419

(57) ABSTRACT

Remote control interfaces (4) are provided with first sub-interfaces (6) comprising converters (61) for generating drive-line-scan-line interactions in response to data signals, and generators (62) for generating command signals in response to the drive-linescan-line interactions. Such remote control interfaces (4) do not make direct and complete translations, but convert arriving data signals, comprising a first device code, into drive-linescan-line interactions, and convert the drive-line-scan-line interactions into command signals comprising a second device code. As a result, the remote control interfaces (4) are low-cost. The converters (61) comprise controllers (64) for generating intermediate signals in response to the data signals, expanders (65) for generating expanded intermediate signals in response to the intermediate signals, and (de)multiplexers (66, 67) for generating the drive-line-scanline interactions in response to the expanded intermediate signals. The remote control interfaces (4) may further comprise second sub-interfaces (7).

The invention relates to a remote control interface, and also relates to a system, and to a control unit, and to a first device, and to methods, and to processor program products.

A system in the invention comprises a control unit for remotely controlling a first device such as a consumer device manufactured by a first manufacturer and comprises a remote control interface for remotely controlling a second device such as a consumer device manufactured by a second manufacturer.

The expression “processor program product” is used herein to refer to software code for being run on data processors or micro-controllers in order to implement the functionality of the invention.

A prior art remote control interface is known from US 2003/0227407 A1, which discloses in its FIG. 2 an existing remote control unit for controlling an existing consumer device. A new consumer device is added to the existing consumer device. This first consumer device uses a first device control code, and the second consumer device uses a second device control code. To be able to control the new consumer device with the existing remote control unit, means for converting the first device control code into the second device control code have been introduced. As disclosed in FIG. 4, these means comprise a controller and a memory. So, the prior art remote control interface comprises a controller and a memory.

The known remote control interface is disadvantageous, inter alia, owing to the fact that it translates first device control codes into second device control codes directly and completely. So, for each combination of two different device control languages, direct and complete translations must be developed and must be stored in the remote control interface. This makes the known remote control interface relatively expensive.

It is an object of the invention, inter alia, to provide a relatively low-cost remote control interface.

Further objects of the invention are, inter alia, to provide a system, a control unit, a first device, methods, and processor program products for use in (combination with) at least a part of the relatively low-cost remote control interface.

It is another object of the invention, inter alia, to enable the use of various types of remote controls and/or standards on one set of equipment.

The remote control interface according to the invention comprises a receiver for receiving a data signal, the data signal comprising data originating from a control unit; a converter for generating a drive-line-scan-line interaction in response to the data signal; a generator for generating a command signal in response to the drive-line-scan-line interaction; and a transmitter for transmitting a wireless output signal in response to the command signal.

By introducing the converter for generating the drive-line-scan-line interaction in response to the data signal originating directly or indirectly from the control unit, and by introducing the generator for generating the command signal in response to the drive-line-scan-line interaction, the remote control interface according to the invention does not make direct and complete translations. Instead, the remote control interface of the invention first converts an arriving data signal comprising a first device code into the drive-line-scan-line interaction, and then converts this drive-line-scan-line interaction into the command signal comprising a second device code. As a result, instead of one complex conversion, now two simple conversions need to be made, and the remote control interface is relatively low-cost.

The conversion of data signals into drive-line-scan-line interactions allows existing generators to be used. The existing generators generate command signals in response to the drive-line-scan-line interactions. Such existing generators are used in existing control units, and then receive their drive-line-scan-line interactions from keyboards. According to the invention, the keyboard is replaced by the converter, with the combination of the converter and the generator constituting the heart of the remote control interface.

US 2004/0027495 discloses a mobile phone being used as a remote control for controlling a device via a remote control interface. Thereto, the mobile phone comprises a Bluetooth transmitter, and the remote control interface comprises a Bluetooth receiver and an infrared transmitter. The Bluetooth receiver and the infrared transmitter are coupled to each other via a central processing unit or CPU. This CPU makes direct and complete translations of the incoming Bluetooth signals into the outgoing infrared signals.

An embodiment of the remote control interface according to the invention is defined by the converter comprising a controller for in response to the data signal generating an intermediate signal; and a (de)multiplexer for generating the drive-line-scan-line interaction in response to the intermediate signal. In this converter, the controller takes care of converting the data signal into the intermediate signal, and the (de)multiplexer takes care of converting the intermediate signal into the drive-line-scan-line interaction. In case of different data signals being possible, different controllers need to be designed, or an adaptive controller needs to be used. The (de)multiplexer can then remain the same. In case of different drive-line-scan-line interactions being required, different (de)multiplexers need to be designed, or an adaptive (de)multiplexer needs to be used. The controller can then remain the same.

An embodiment of the remote control interface according to the invention is defined by the converter comprising a controller for generating an intermediate signal in response to the data signal; an expander for generating expanded intermediate signals in response to the intermediate signal; and a (de)multiplexer for generating the drive-line-scan-line interaction in response to the expanded intermediate signals. In this converter, the controller and the expander take care of converting the data signal into the expanded intermediate signals, and the (de)multiplexer takes care of converting the expanded intermediate signals into the drive-line-scan-line interaction. In case of different data signals being possible, different controllers need to be designed, or an adaptive controller needs to be used. The (de)multiplexer can then remain the same. In case of different drive-line-scan-line interactions being required, different (de)multiplexers need to be designed, or an adaptive (de)multiplexer needs to be used. The controller can then remain the same.

An embodiment of the remote control interface according to the invention is defined by the (de)multiplexer comprising a first (de)multiplexer circuit for generating a control signal in response to first expanded intermediate signals and drive-line signals, the drive-line signals originating from the generator; and a second (de)multiplexer circuit for generating scan-line signals in response to second expanded intermediate signals and the control signal, the scan-line signals being destined for the generator. The drive-line signals and the scan-line signals together constitute the drive-line-scan-line interaction. This (de)multiplexer comprises two (de)multiplexer circuits such as for example two 74HC4051 integrated circuits. Then, the expander for example comprises the PCF8574 integrated circuit, and the generator for example comprises the uPD17240MC integrated circuit. This embodiment is extremely low-cost and extremely simple. However, many other embodiments of the remote control interface according to the invention and/or of the converter and/or of the (de)multiplexer are possible without departing from the scope of this invention. For example, the controller and the expander might be integrated into a single circuitry.

An embodiment of the remote control interface of the invention is defined by the receiver being a wireless receiver and the data signal being a wireless data signal. Such a wireless data signal may originate directly or indirectly from the remote control unit and may be for example infrared, radio frequency, ultrasonic, laser beam or acoustical.

An embodiment of the remote control interface of the invention is defined by the receiver being a non-wireless receiver and the data signal being a non-wireless data signal. Such a non-wireless data signal may be for example a wired signal originating indirectly from the control unit.

An embodiment of the remote control interface of the invention is defined by comprising the receiver and further comprising an other receiver, each being able to receive in accordance with different wireless control standards.

An embodiment of the remote control interface of the invention is defined by comprising the transmitter and further comprising an other transmitter, each being able to transmit in accordance with different wireless control standards.

An embodiment of the remote control interface of the invention is defined by further comprising a further receiver for receiving a remote control signal, which is a wireless signal and which comprises data originating from the control unit; a translator for translating the remote control signal into the data signal; and a further transmitter for transmitting the data signal to the receiver. This remote control interface comprises two sub-interfaces. A first sub-interface comprises the receiver, the converter, the generator and the transmitter. A second sub-interface comprises the further receiver, the translator and the further transmitter. Both sub-interfaces may be located in one housing, in which case the further transmitter and the receiver will exchange non-wireless or wired signals. Both sub-interfaces may also be located in separate housings, in which case the further transmitter and the receiver either exchange non-wireless or wired signals or exchange wireless signals such as for infrared, radio frequency, ultrasonic, laser beam or acoustical signals.

The system according to the invention comprises a control unit for remotely controlling a first device and further comprises a remote control interface for remotely controlling a second device. The remote control interface comprises a receiver for receiving a data signal, the data signal comprising data originating from the control unit; a converter for generating a drive-line-scan-line interaction in response to the data signal; a generator for generating a command signal in response to the drive-line-scan-line interaction; and a transmitter for transmitting a wireless output signal in response to the command signal.

An embodiment of the system of the invention is defined by further comprising the first device.

The control unit according to the invention is designed for use in a system that has the control unit for remotely controlling a first device and further has a remote control interface for remotely controlling a second device. The remote control interface of the system comprises a receiver for receiving a data signal comprising data originating from the control unit; a converter for generating a drive-line scan-line interaction in response to the data signal; a generator for generating a command signal in response to the drive-line-scan-line interaction; and a transmitter for transmitting a wireless output signal in response to the command signal. The control unit for use in above system comprises: a first transmitter for transmitting a remote control signal to the first device, the first transmitter comprising a wireless transmitter using a first wireless transmission standard; and a second transmitter for transmitting the data signal to the receiver, the second transmitter comprising a wireless transmitter using a second wireless transmission standard different from the first wireless transmission standard. In other words, the control unit according to the invention comprises, in addition to its first transmitter being for example an infrared transmitter, a part of the second sub-interface in the form of the second transmitter being an other wireless transmitter using a different wireless transmission standard. The control unit according to the invention controls the first device directly and controls the second device indirectly via the second sub-interface.

The first device according to the invention is designed for use in a system comprising a control unit for remotely controlling the first device and further comprising a remote control interface for remotely controlling a second device. The remote control interface of the system comprises: a receiver for receiving a data signal with data originating from the control unit; a converter for generating a drive-line-scan-line interaction in response to the data signal; a generator for generating a command signal in response to the drive-line-scan-line interaction; and a transmitter for transmitting a wireless output signal in response to the command signal. The first device for use in such as system comprises a further receiver for receiving a remote control signal, the remote control signal comprising a wireless signal and comprising data originating from the control unit; a translator for translating the remote control signal into the data signal; and a further transmitter for transmitting the data signal to the receiver. In other words, the first device according to the invention comprises the second sub-interface, which communicates with the first sub-interface. This first device is controlled through the control unit directly, and the second device is controlled through the remote control indirectly via the second and first sub-interface.

A first method according to the invention comprises the steps of: receiving a data signal, with data to control a device; in response to the data signal generating a drive-line-scan-line interaction; and in response to the drive-line-scan-line instructing the device to perform an action. In normal operation the device might use the drive-line-scan-line interaction to receive controls from a keyboard.

A second method according to the invention comprises the steps of: receiving a data signal, with data originating from a control unit; in response to the data signal generating a drive-line-scan-line interaction; in response to the drive-line-scan-line interaction generating a command signal; and in response to the command signal transmitting a wireless output signal.

A first processor program product according to the invention comprises the functions of: receiving a data signal, which comprises data originating from a control unit; and in response to the data signal generating a drive-line-scan-line interaction.

A second processor program product according to the invention comprises the functions of: receiving a data signal, which comprises data originating from a control unit; in response to the data signal generating a drive-line-scan-line interaction; in response to the drive-line-scan-line interaction generating a command signal; and in response to the command signal transmitting a wireless output signal.

Each processor program product might comprise sub-modules, which run on separate processors.

Embodiments of the system according to the invention and of the first device according to the invention and of the control unit according to the invention and of the methods according to the invention and of the processor program products according to the invention correspond with the embodiments of the remote control interface according to the invention.

The invention is based upon an insight, inter alia, that one complex conversion can be replaced by two simple conversions, and is based upon a basic idea, inter alia, that a converter is to be used for generating a drive-line-scan-line interaction in response to a data signal and that a generator is to be used for generating a command signal in response to the drive-line-scan-line interaction.

The invention solves the problem, inter alia, of providing a relatively low-cost remote control interface, and is advantageous, inter alia, in that existing generators from control units, which are produced in very large quantities, can be used, with the converters replacing the control unit keyboards. The combination of the converter and the generator constitute the heart of the remote control interface.

These and other aspects of the invention will be apparent from and elucidated with reference to the embodiments(s) described hereinafter.

### IN THE DRAWINGS

FIG. 1 is a diagram of a system in the invention, comprising a control unit for remotely controlling a first device and further comprising a remote control interface according to the invention for remotely controlling a second device;

FIG. 2 is a diagram of a system of the invention, comprising a control unit for remotely controlling a first device and further comprising a remote control interface according to the invention for remotely controlling a second device;

FIG. 3 is a diagram of a system of the invention, comprising a control unit for remotely controlling a first device according to the invention and further comprising a remote control interface according to the invention for remotely controlling a second device;

FIG. 4 is a diagram of a system in the invention, comprising a control unit according to the invention for remotely controlling a first device and further comprising a remote control interface according to the invention for remotely controlling a second device;

FIG. 5 is a diagram of a first sub-interface of a remote control interface according to the invention;

FIG. 6 is a diagram of a universal embodiment of the first sub-interface of a remote control interface according to the invention of FIG. 5; and

FIG. 7 is a diagram of a second sub-interface of a remote control interface according to the invention.

As a specific example, consider an IR blaster that is a transmitter for transferring data to a peripheral device via infrared. The blaster can be used in a scenario wherein , e.g., IR commands from a remote control device are transcoded to another format usable by legacy peripheral devices that cannot respond to commands from the remote control device directly. The inventor proposes to implement the blaster as follows. The blaster's controller is identical to a controller as used in a remote control device. Circuitry is connected to the controller identical to that used to detect a key being pressed on a keyboard (at the remote). The key-detecting circuitry is to receive data that causes the circuitry to simulate a key press that gets transcoded to IR via the controller. Advantages of this configuration are manifold: this is an inexpensive manner of implementing a blaster as the implementation uses standard components; in the invention usage of an expensive remote control code data base can be avoided; and control data is simple as only key presses are to be simulated.

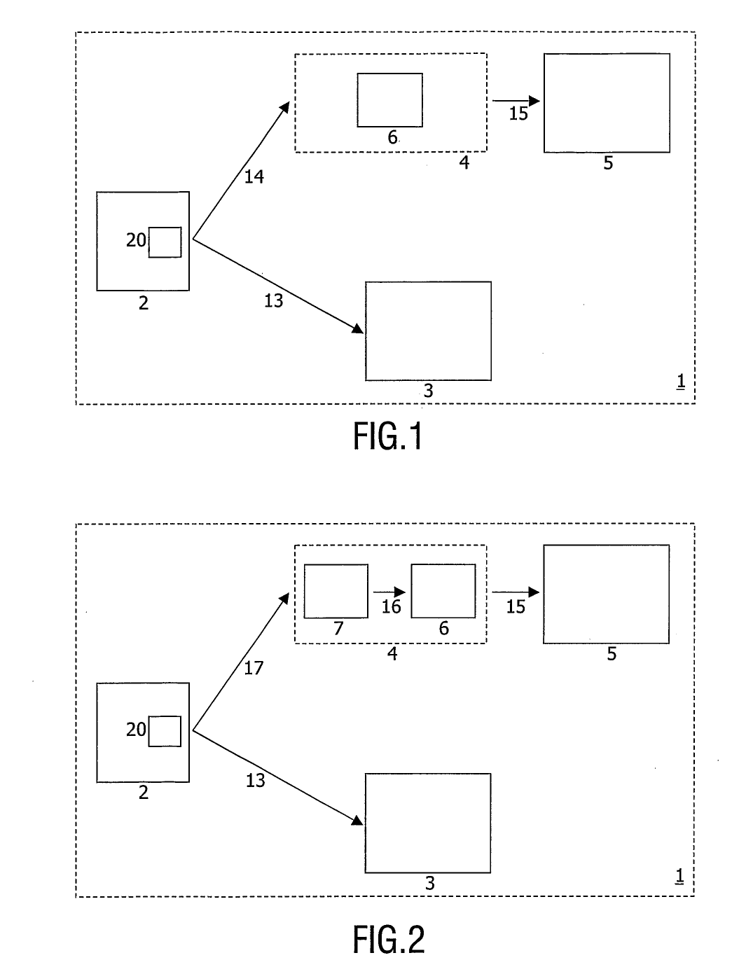

The system 1 according to the invention shown in FIG. 1 comprises a (prior art) control unit 2 such as for example a remote control unit for remotely controlling a first (prior art) device 3, and further comprises a remote control interface 4 according to the invention for remotely controlling a second (prior art) device 5. The control unit 2 comprises a first (prior art) wireless transmitter 20 for transmitting wireless information 13 to the first device 3 and for transmitting wireless information 14 to the remote control interface 4. This remote control interface 4 comprises a first sub-interface 6 for receiving the wireless information 14 and for transmitting wireless information 15 to the second device 5. The control unit 2 and the first device 3 are for example manufactured by a first manufacturer, and the second device 5 is for example manufactured by a second manufacturer. This first device 3 uses a first device control code, and the second device 5 uses a second device control code. As a result, the first device 3 is controlled directly through the control unit 2, and the second device 5 is controlled indirectly through the control unit 2 via the remote control interface 4.

The system 1 according to the invention shown in FIG. 2 corresponds with the system 1 according to the invention as shown in FIG. 1, apart from the fact that the remote control interface 4 according to the invention now comprises a first sub-interface 6 and a second sub-interface 7. The second sub-interface 7 receives information 17 from the control unit 2 and transmits information 16 to the first sub-interface 6, which first sub-interface 6 transmits the information 15 to the second device 5. The information 16 may be supplied via a wired channel or via a wireless channel such as for example an infrared, radio frequency, ultrasonic, laser beam or acoustical channel. Such a wired channel is lower in cost then a wireless channel. It is however less user friendly.

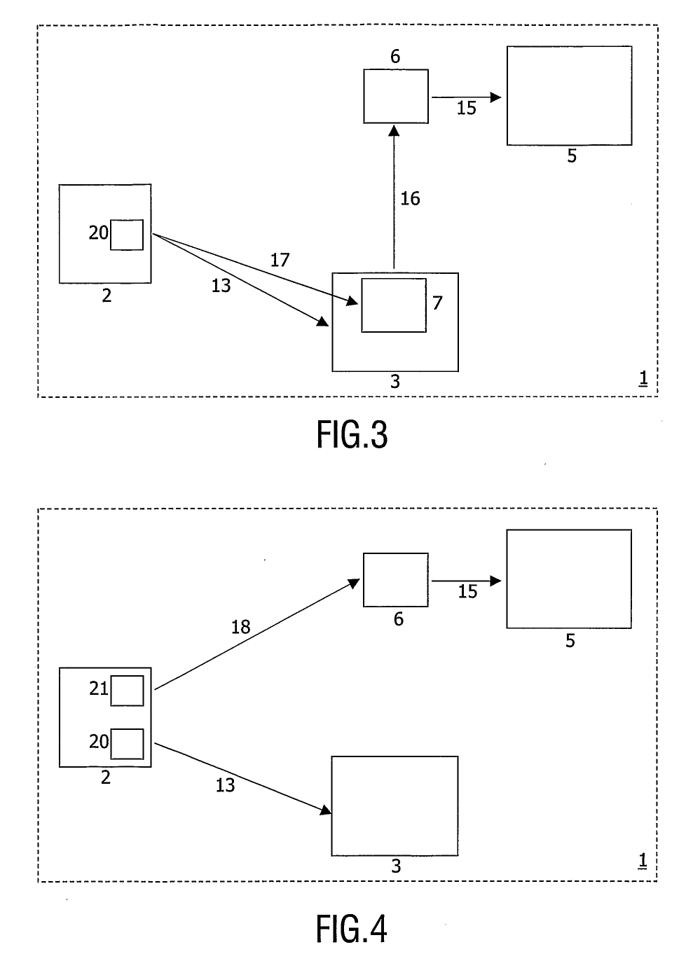

The system 1 according to the invention shown in FIG. 3 corresponds with the system 1 according to the invention as shown in FIG. 2, apart from the fact that the second sub-interface 7 has been located and/or integrated into the first device 3 according to the invention. The second sub-interface 7 receives the information 17 from the control unit 2 and transmits the information 16 to the first sub-interface 6. Again the information 16 may be supplied via a wired channel or via a wireless channel such as for example an infrared, radio frequency, ultrasonic, laser beam or acoustical channel. The information 13 and 17, both originating from the same first wireless transmitter 20, are shown as separate information streams, owing to the fact that the first device 3 comprises a (prior art) receiver for receiving the information 13 and comprises a receiver forming part of the second sub-interface 7 for receiving the information 17. In case these two receivers are combined and/or integrated, the information 13 and 17 can be shown as one combined information stream 13,17.

The system 1 according to the invention shown in FIG. 4 corresponds with the system 1 according to the invention as shown in FIG. 1, apart from the fact that the first sub-interface 6 receives information 18 now directly from the control unit 2 according to the invention. Thereto, the control unit 2 according to the invention has been provided with, in addition to the first (prior art) transmitter 20, a second transmitter 21, both transmitters using a different transmission standard. So, in this case, the information 18 is supplied via a wireless channel such as for example an infrared, radio frequency, ultrasonic, laser beam or acoustical or an other wireless channel.

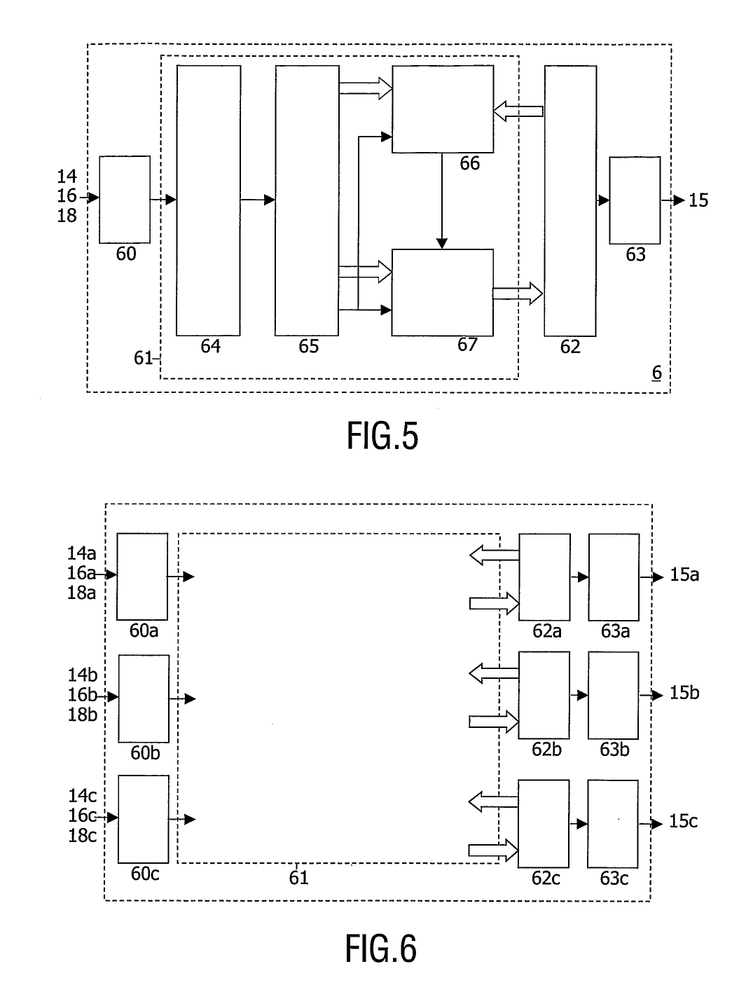

The first sub-interface 6 shown in FIG. 5 of the remote control interface 4 according to the invention comprises a receiver 60 for receiving a data signal, which data signal comprises data originating from the control unit 2. This data signal either arrives directly from the control unit 2, as shown in FIGS. 1 and 4, in which case the data signal corresponds with the information 14 or the information 18, or arrives indirectly from the control unit 2 via the second sub-interface 7, as shown in FIGS. 2 and 3, in which case the data signal corresponds with the information 16. This information 16 may be wired information (with the receiver 60 being a wired receiver) or wireless information (with the receiver 60 being a wireless receiver). The first sub-interface 6 further comprises a converter 61 for in response to the data signal generating a drive-line-scan-line interaction, a generator 62 for in response to the drive-line-scan-line interaction generating a command signal, and a transmitter 63 for in response to the command signal transmitting a wireless output signal. This wireless output signal corresponds with the wireless information 15 shown in FIG. 1-4.

The converter 61 comprises a controller 64 for in response to the data signal generating an intermediate signal and an expander 65 for in response to the intermediate signal generating expanded intermediate signals, and a (de)multiplexer 66,67 for in response to the expanded intermediate signals generating the drive-line-scan-line interaction. The (de)multiplexer 66,67 comprises a first (de)multiplexer circuit 66 for in response to first expanded intermediate signals and drive-line signals generating a control signal, which drive-line signals originate from the generator 62, and a second (de)multiplexer circuit 67 for in response to second expanded intermediate signals and the control signal generating scan-line signals, which scan-line signals are destined for the generator 62, whereby the drive-line signals and the scan-line signals together constitute the drive-line-scan-line interaction. Between controller 64 and expander 65, there might be a so-called I²C connection.

This (de)multiplexer 66,67 comprises two (de)multiplexer circuits 66 and 67 such as for example two 74HC4051 integrated circuits. The expander 65 for example comprises the PCF8574 integrated circuit, and the generator 62 for example comprises the uPD17240MC integrated circuit. Then, six drive-line outputs of the generator 62 are coupled to inputs Y0-Y5 of the (de)multiplexer circuit 66, and seven scan-line inputs of the generator 62 are coupled to outputs Y0-Y6 of the (de)multiplexer circuit 67. An output Z of the (de)multiplexer circuit 66 is coupled to an input Z of the (de)multiplexer 67. Three inputs S0-S2 of the (de)multiplexer circuit 66 are coupled to outputs P0-P2 of the expander 65, and three inputs S0-S2 of the (de)multiplexer circuit 67 are coupled to outputs P3-P5 of the expander 65. An output P6 of the expander 65 is coupled to the inputs E of each (de)multiplexer circuit 66,67. The first expanded signals at the outputs P0-P2 determine which one of the Y0-Y5 inputs of the (de)multiplexer circuit 66 is coupled to the output Z of the (de)multiplexer circuit 66, and the second expanded signals at the outputs P3-P5 determine which one of the Y0-Y5 outputs of the (de)multiplexer circuit 67 is coupled to the input Z of the (de)multiplexer circuit 67.

As a result, the conversion of data signals into drive-line-scan-line interactions allows prior art generators 62 to be used, which prior art generators 62 generate command signals in response to the drive-line-scan-line interactions. Such prior art generators 62 are used in prior art control units, and then receive their drive-line-scan-line interactions from keyboards. According to the invention, the keyboard is replaced by the converter 61, with the combination of the converter 61 and the generator 62 constituting the heart of the remote control interface 4 according to the invention.

FIG. 6 shows a universal embodiment of FIG. 5, capable of receiving and transmitting a wide variation of wireless standards. The embodiment of FIG. 6 contains multiple receivers 60a, 60b, 60c, etc., to receive for example infrared, radio frequency, ultrasonic, laser beam or acoustical signals and contains multiple transmitters 63a, 63b, 63c, etc. Each transmitter has its corresponding generator 62a, 62b, 62c, etc. to transmit for example infrared, radio frequency, ultrasonic, laser beam or acoustical signals. This embodiment might contain for example two transmitters, each being coupled to a different or the same generator, and might contain for example two generators, each being coupled to a different or the same transmitter.

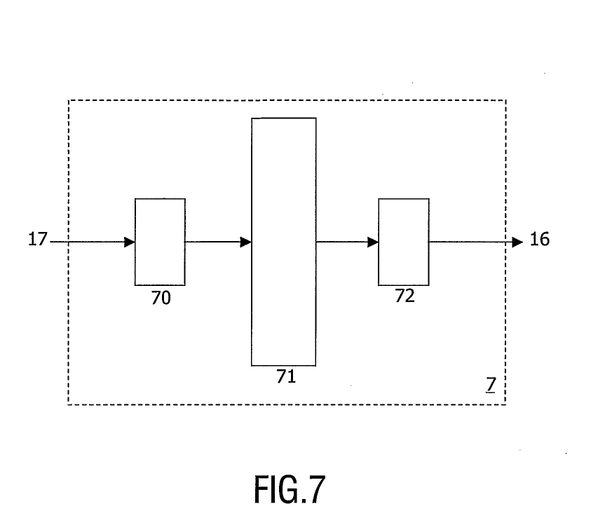

The second sub-interface 7 shown in FIG. 7 of a remote control interface 4 according to the invention comprises a further receiver 70 for receiving a remote control signal, which remote control signal is a wireless signal and comprises data originating from the control unit 2, a translator 71 for translating the remote control signal into the data signal, and a further transmitter 72 for transmitting the data signal to the receiver 60. This remote control signal may arrive directly from the control unit 2, as shown in FIGS. 2 and 3, in which case the remote control signal corresponds with the wireless information 17. Therefore, the further receiver 70 is a wireless receiver. The further transmitter 72 is, in dependence of the kind of data signal used, a wired transmitter or an infrared transmitter or a radio frequency transmitter etc. Between the translator 71 and the further transmitter 72, there might be a so-called PCI, USB or Ethernet connection.

It should be noted that the above-mentioned embodiments illustrate rather than limit the invention, and that those skilled in the art will be able to design many alternative embodiments without departing from the scope of the appended claims. E.g. the invention might also be used to interface equipment using various standards such as Bluetooth, ZigBee, 802.11a, and more. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A remote control interface (4) comprising
a receiver (60) for receiving a data signal that comprises data originating from a control unit (2);
a converter (61) for generating a drive-line-scan-line interaction in response to the data signal;
a generator (62) for generating a command signal in response to the drive-line-scan-line interaction; and
a transmitter (63) for transmitting a wireless output signal in response to the command signal.

2. The remote control interface (4) of claim 1, wherein the converter (61) comprises:
a controller (64) for generating an intermediate signal in response to the data signal; and
a (de)multiplexer (66,67) for generating the drive-line-scan-line interaction in response to the intermediate signal.

3. The remote control interface (4) of claim 1, wherein the converter (61) comprises:
a controller (64) for generating an intermediate signal in response to the data signal;
an expander (65) for generating expanded intermediate signals in response to the intermediate signal; and
a (de)multiplexer (66,67) for generating the drive-line-scan-line interaction in response to the expanded intermediate signals.

4. The remote control interface (4) of claim 3, wherein the (de)multiplexer (66,67) comprises:
a first (de)multiplexer circuit (66) for generating a control signal in response to first expanded intermediate signals and drive-line signals, the drive-line signals originating from the generator (62); and
a second (de)multiplexer circuit (67) for generating scan-line signals in response to second expanded intermediate signals and the control signal, the scan-line signals being destined for the generator (62);
and wherein the drive-line signals and the scan-line signals together constitute the drive-line-scan-line interaction.

5. The remote control interface (4) of claim 1, wherein the receiver (60) comprises a wireless receiver and wherein the data signal comprises a wireless data signal.

6. The remote control interface (4) of claim 1, wherein the receiver (60) comprises a non-wireless receiver and wherein the data signal comprises a non-wireless data signal.

7. The remote control interface (4) of claim 1, comprising the receiver (60a) and further comprising another receiver (60b), each being operative to receive in accordance with different wireless control standards.

8. The remote control interface (4) of claim 1, comprising the transmitter (63a) and further comprising another transmitter (63b), each being operative to transmit in accordance with different wireless control standards.

9. The remote control interface (4) of claim 1, further comprising: a further receiver (70) for receiving a remote control signal, which comprises a wireless signal and comprises data originating from the control unit (2); a translator (71) for translating the remote control signal into the data signal; and a further transmitter (72) for transmitting the data signal to the receiver (60).

10. A system (1) comprising a control unit (2) for remotely controlling a first device (3) and further comprising a remote control interface (4) for remotely controlling a second device (5), wherein the remote control interface (4) comprises: a receiver (60) for receiving a data signal with data originating from the control unit (2); a converter (61) for generating a drive-line-scan-line interaction in response to the data signal; a generator (62) for generating a command signal in response to the drive-line-scan-line interaction; and a transmitter (63) for transmitting a wireless output signal in response to the command signal.

11. The system (1) of claim 10, further comprising the first device (3).

12. A control unit (2) for use in a system (1) for remotely controlling a first device (3), the system comprising a remote control interface (4) for remotely controlling a second device (5), wherein the remote control interface (4) comprises: a receiver (60) for receiving a data signal comprising data originating from the control unit (2); a converter (61) for generating a drive-line-scan-line interaction in response to the data signal; a generator (62) for generating a command signal in response to the drive-line-scan-line interaction; and a transmitter (63) for transmitting a wireless output signal in response to the command signal; and wherein the control unit (2) comprises: a first transmitter (20) for transmitting a remote control signal to the first device (3), the first transmitter (20) comprising a wireless transmitter using a first wireless transmission standard; and a second transmitter (21) for transmitting the data signal to the receiver (60), the second transmitter (20) comprising, a wireless transmitter using a second wireless transmission standard different from the first wireless transmission standard.

13. A first device (3) for use in a system (1), the system comprising a control unit (2) for remotely controlling the first device (3) and further comprising a remote control interface (4) for remotely controlling a second device (5), wherein the remote control interface (4) comprises: a receiver (60) for receiving a data signal comprising data originating from the control unit (2); a converter (61) for generating a drive-line-scan-line interaction in response to the data signal; a generator (62) for generating a command signal in response to the drive-line-scan-line interaction; and a transmitter (63) for transmitting a wireless output signal in response to the command signal; and wherein the first device (3) comprises: a further receiver (70) for receiving a remote control signal comprising a wireless signal and comprising data originating from the control unit (2); a translator (71) for translating the remote control signal into the data signal; and a further transmitter (72) for transmitting the data signal to the receiver (60).

14. A method of controlling a device, the method comprising the steps of
receiving a data signal comprising data for control of a device;
in response to the data signal generating a drive-line-scan-line interaction; and
in response to the drive-line-scan-line instructing the device to perform an action.

15. A method of generating a command signal, the method comprising the steps of:
receiving a data signal with data originating from a control unit (2);
in response to the data signal generating a drive-line-scan-line interaction;
in response to the drive-line-scan-line interaction generating the command signal; and
in response to the command signal transmitting a wireless output signal.

16. A processor program product comprising the functions of:
receiving a data signal with data originating from a control unit (2); and
in response to the data signal generating a drive-line-scan-line interaction.

17. The processor program product of claim 16 further comprising the functions of:
in response to the drive-line-scan-line interaction generating a command signal; and
in response to the command signal transmitting a wireless output signal.
